(19) United States
(12) Patent Application Publication
(10) Pub. No.: US 2005/0107917 A1
(43) Pub. Date: May 19, 2005

(54) Robotic system for sequencing multiple specimens between a holding tray and a microscope

(76) Inventors: Paul Edward Smith, San Clemente, CA (US); Michael Patrick Callahan, St. Valinda, CA (US); Ingo Daniel, Laguna Beach, CA (US); Clinton Stearns Potter, San Diego, CA (US); Bridget Olivia Carragher, San Diego, CA (US); Christian James Marshall Suloway, San Diego, CA (US)

Correspondence Address: LAW OFFICES OF ERIC KARICH, 2807 ST. MARK DR., MANSFIELD, TX, 76063, US

(21) Appl. No.: 10/714,217

(22) Filed: Nov. 14, 2003

(51) Int. Cl. G06F 19/00

(52) U.S. Cl. 700/245

(57) ABSTRACT

A system for inserting a specimen-containing holder into a microscope has a robotic arm, an end effector, and a control mechanism such as a personal computer. The end effector is attached to an end of the robotic arm and includes a gripper apparatus adapted to grip the holder. The control means is operably connected to the robotic arm and to the gripper apparatus and configured to control the robotic arm and the gripper apparatus such that the gripper apparatus grips the holder, and the robotic arm inserts the gripped holder into the microscope.

### BACKGROUND OF THE INVENTION

1. Field of the Invention

This invention relates generally to automated handling systems, and more particularly to automated handling systems for microscope specimens.

2. Description of Related Art

Transmission electron microscopes (TEMs) are commonly used to examine the internal structures of objects called specimens. A typical TEM includes a vertical metal cylinder or column. A beam of electrons is produced within the column and passed through a specimen. As the electron beam passes through the specimen, some electrons are scattered, and the remainder are focused onto a phosphorescent screen (or photographic film) to form an image of the internal structure of the specimen. In the case of a phosphorescent screen, electrons striking the screen cause visible light to be generated, forming the image. Lighter areas of the image represent thinner and/or less dense areas of the specimen that more electrons passed through, and darker areas of the image represent thicker and/or more dense areas of the specimen that fewer electrons passed through. Specimens for TEM examination are typically positioned on a specimen grid. Using forceps, a user (i.e., operator) typically inserts a selected specimen grid into a specimen holder. The operator then inserts the specimen holder into the column of the TEM for examination.

Several problems arise in TEM examination when many specimens are to be examined. First, the specimen holder of the typical TEM is configured to hold only one specimen grid at a time. As a result, the specimens must be examined one after another in sequence. After examining one specimen, the operator typically removes the specimen holder from the column of the TEM, uses the forceps to remove the corresponding specimen grid from the specimen holder, inserts another specimen grid into the specimen holder using the forceps, and inserts the specimen holder back into the column of the TEM. This repetitive process quickly becomes tedious and time consuming, and the required manipulation of the small specimen grids using forceps makes the process prone to error.

### SUMMARY OF THE INVENTION

The present invention teaches certain benefits in construction and use which give rise to the objectives described below.

The present invention provides a system for inserting a specimen-containing holder into a microscope. The system has a robotic arm, an end effector, and a control means. The end effector is attached to an end of the robotic arm and includes a gripper apparatus adapted to grip the holder. The control means is operably connected to the robotic arm and to the gripper apparatus and configured to control the robotic arm and the gripper apparatus such that the gripper apparatus grips the holder, and the robotic arm inserts the gripped holder into the microscope.

A primary objective of the present invention is to provide a system for inserting a specimen-containing holder into a microscope, the system having advantages not taught by the prior art.

Another objective is to provide a system that is capable of automatically grasping a grid and moving the grid into a specimen-containing holder.

Another objective is to provide a system that is capable of automatically grasping the specimen-containing holder and inserting the specimen into a microscope.

A further objective is to provide a system that enables the more efficient utilization of a microscope by successfully automating the loading and unloading of the microscope.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a diagram of a system for handling specimens to be examined by a transmission electron microscope (TEM), wherein the system includes a robotic arm, an end effector attached to an end of the arm and including a specimen grid (i.e., grid) gripper and a specimen holder (i.e., holder) gripper, a grid tray for storing grids, and a probe station;

FIG. 2 is a perspective view of a spatial arrangement of several of the components of the system of FIG. 1, including the robotic arm, the end effector, the grid tray, and the probe station;

FIG. 3 is a side elevation view of one embodiment of the end effector of FIGS. 1 and 2;

FIG. 4 is a front elevation view of the grid gripper of FIGS. 1 and 3;

FIG. 5A is a top plan view of a typical grid;

FIG. 5B is a side elevation view of the typical grid of FIG. 5A;

FIG. 6 is a perspective view of one embodiment the grid tray of FIGS. 1 and 2, wherein the grid tray includes a base having an upper surface with pockets formed therein for storing grids;

FIG. 7 is a top plan view of one of the pockets of FIG. 6; and

FIG. 8 is a perspective view of one embodiment of the probe station of FIGS. 1 and 2.

### DETAILED DESCRIPTION OF THE INVENTION

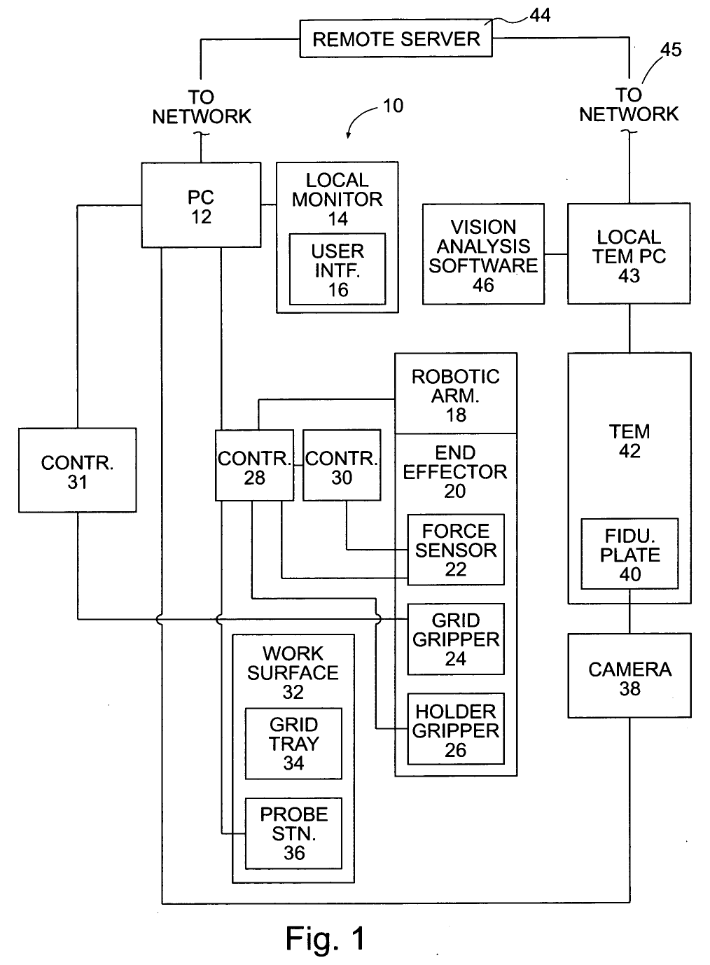

FIG. 1 is a diagram of a system 10 for handling specimens to be examined by a transmission electron microscope (TEM) 42. In the embodiment of FIG. 1, the system 10 includes a control means and a robotic arm 18. The control means preferably includes a personal computer (PC) 12, a local monitor 14, a user interface 16, a first controller 28, a second controller 30, and a third controller 31. The robotic arm 18 has an end effector 20 that includes a force sensor 22, a grid gripper 24, and a holder gripper 26. The system 10 may also include a work surface 32 having a grid tray 34 and a probe station 36 positioned thereon, a camera 38, and a fiducial plate 40 attached to the TEM 42. The TEM 42 is preferably operably attached to a local TEM PC, which is operably attached to a remote server 44 and the PC 12 via a network 45.

The PC 12 and the local TEM PC 43 each include a central processing unit (CPU) (such as a microprocessor), a memory system, and other components (not sown). Since this construction is well known in the art, it is not described in greater detail herein. Software is stored within a memory system (not shown) of the PC 12 to control various components of the system 10, and the CPU executes instructions of the software (i.e., runs the software). Some or all of the software may be, for example, written in the Microsoft® Visual BASIC® language (Microsoft Corporation, Redmond, Wash.). As indicated in FIG. 1, the PC 12 may be connected to the remote server 44 via the network 45. Functions performed by the PC 12 may be controlled from the user interface 16 of the local monitor 14 or from a remote device via the network. The network 45 is also used to exchange software signals between the PC 12 and the local TEM PC 43, thereby enabling communication between the TEM 42 and the robotic arm 18 (so that, for example, the TEM 42 can tell the robotic arm 18 when to insert and/or remove the sample).

The TEM PC 45 may include a vision analysis means, such as a vision analysis software 46 that enables the TEM 42 to use vision analysis to automatically scan wide areas of specimen grids (i.e., grids) at low magnifications and then focus in on points of interest, such as molecules, and then scan them at higher modifications. The vision analysis software 46 enables the system to automatically load, scan, and record high volumes of samples. An acceptable form of the vision analysis software 46 is called LEGINON automated data collection software, developed by The Scripps Research Institute, of La Jolla, Calif.

The robotic arm 18 may be a 6-axis articulated robotic arm. A suitable robotic arm is the model number RX60 manufactured by the Staubli Corporation (Duncan, S.C.) having a maximum load capacity of about 10 lbs., a reach of approximately 28 inches, and a repeatability of about +/−20 microns.

The controller 28 is operably connected between the PC 12 and the robotic arm 18, and controls the robotic arm 18. A suitable controller is the brand Adept, model number CS7B manufactured for the Staubli Corporation (Duncan, S.C.). In one embodiment, the controller 28 receives digital input signals from the robotic arm 18 and provides digital output signals to the robotic arm 18 (e.g., control signals to actuate pneumatic valves). The PC 12 and the controller 28 communicate via an Ethernet(I connection (Xerox Corporation, Stamford, Conn.). Motion tasks are stored as subroutines in the controller 28 and executed as needed by the PC 12.

While one embodiment of the control means is described in detail herein, the scope of the present invention should not be limited to this embodiment, but should include alternative constructions and arrangements that may be devised by those skilled in the art.

In general, the force sensor 22 produces one or more signals indicative of one or more forces present in the end effector 20. The signal(s)s are preferably indicative of forces in 3 orthogonal directions. A suitable force sensor is the Gamma model manufactured by ATI Industrial Automation (Apex, N.C.). The controller 30 is operably connected between the controller 28 and the force sensor 22. The controller 30 receives the one or more signals from the force sensor 22, and provides signal(s) indicative of the corresponding forces to the controller 28. The controller 28 provides control signals to the robotic arm 18 dependent on the signal(s) from the controller 30.

The grid gripper 24 is used to grip grids, and is controlled by the PC 12. As described below, the grid gripper 24 includes two opposed fingers controlled by a 2-axis gripper actuator. A suitable 2-axis gripper actuator is the model number GRP17-05-05-5 manufactured by the SMAC Company (Carlsbad, Calif.) and having a gripper stoke of about 0.2 in per finger. In one embodiment, the PC 12 and the grid gripper 24 communicate via the well known RS-232 protocol.

The holder gripper 26 is used to grip a handle end of a specimen holder. Like the grid gripper 24, the holder gripper 26 includes two opposed fingers controlled by a 2-axis gripper actuator. The actuator of the holder gripper 26 is preferably a pneumatic gripper actuator. A suitable 2-axis pneumatic true parallel gripper actuator is the model number RPG 251 WCX manufactured by the NUMATICS Company, of Highland, Mich. Like the grid gripper 24, the holder gripper 26 is controlled by the PC 12.

The camera 38 is trained on the fiducial plate 40 attached to the TEM 42, and is operably connected to the PC 12 as indicated in FIG. 1. The PC 12 receives image signals from the camera 38 and uses the image signals to create an image. The PC 12 analyzes the image to determine if the position of the TEM 42 has changed.

The TEM 42 may be, in general, any TEM having a removable specimen holder, such as the model manufactured by the FEI Company (Hillsboro, Oreg.).

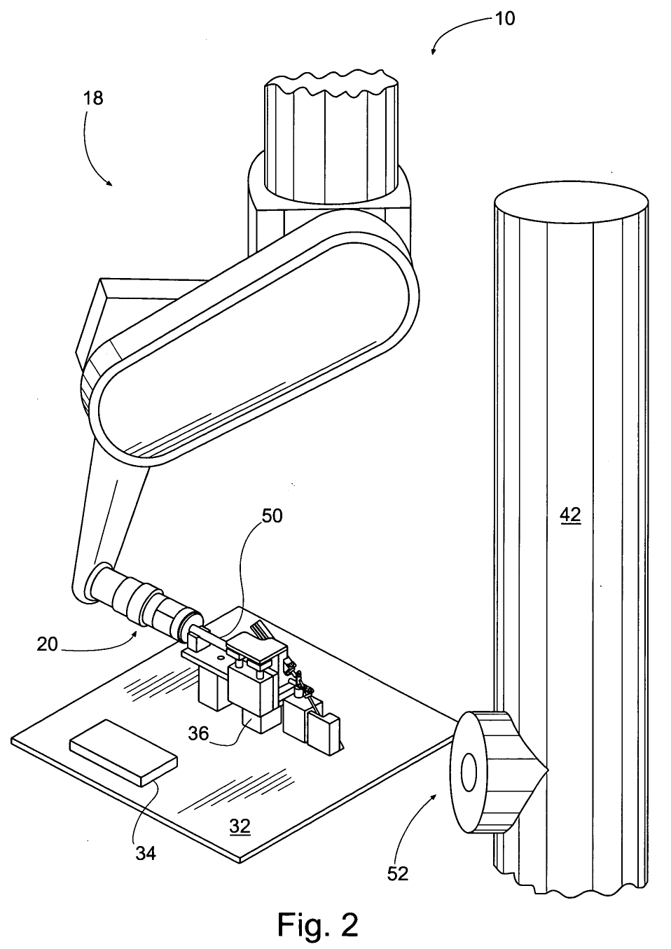

FIG. 2 is a perspective view of a spatial arrangement of several of the components of the system 10 of FIG. 1. In FIG. 2, the robotic arm 18 is suspended from above, and the holder gripper of the end effector 20 is gripping a handle end of a specimen holder 50. The specimen holder 50 is held in two “U”-shaped cradles of the probe station 36. As described above, the grid tray 34 and the probe station 36 are positioned on the work surface 32. The TEM 42 has an airlock entryway 52 dimensioned to receive the specimen holder 50.

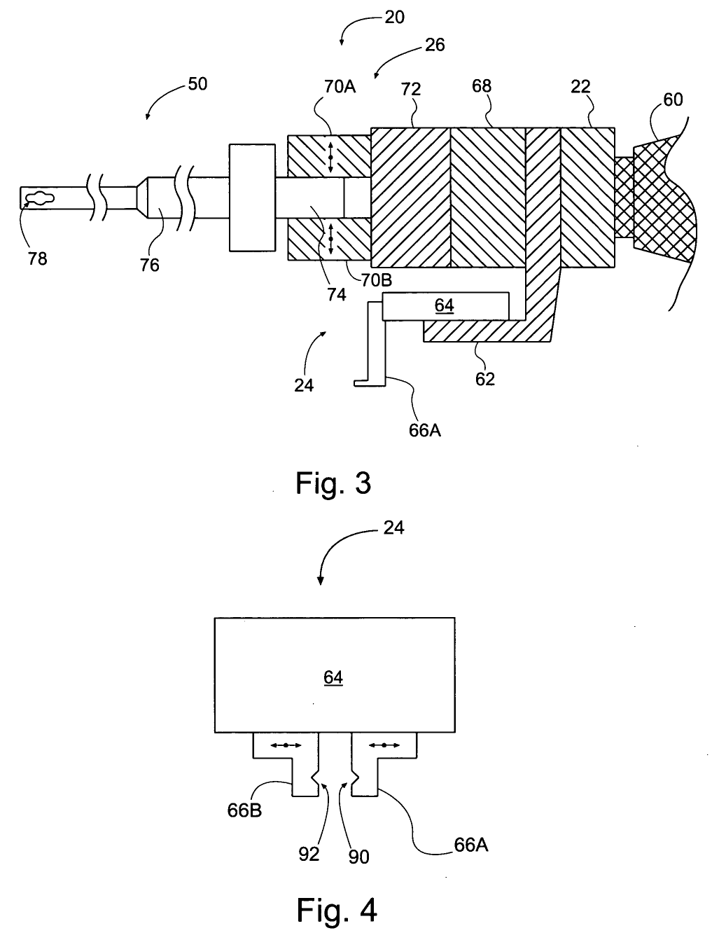

FIG. 3 is a side elevation view of one embodiment of the end effector 20 of FIGS. 1 and 2 wherein the holder gripper 26 of the end effector 20 is gripping a handle end 74 of the specimen holder 50. As described above, the end effector 20 includes the force sensor 22, the grid gripper 24, and the holder gripper 26. In the embodiment of FIG. 3, the force sensor 22 is positioned adjacent to an end 60 of the robot arm 18. The grid gripper 24 is connected to the end effector 20 via a bracket 62. The grid gripper 24 includes two opposed fingers controlled by a 2-axis gripper actuator 64. One of the two fingers is labeled 66A in FIG. 3.

In the embodiment of FIG. 3, the holder gripper 26 is positioned at a tip of the end effector 20 opposite the end 60 and includes two opposed fingers 70A-70B controlled by a 2-axis gripper actuator 72. In FIG. 3 the fingers 70A-70B of the holder gripper 26 are shown gripping the handle end 74 of the specimen holder 50.

In the embodiment of FIG. 3, the specimen holder 50 includes a probe end 76 opposite the handle end 74. A tip of the probe end 76 has an opening 78 passing therethrough. The opening 78 is adapted to receive a grid gripped between the two fingers tips of the grid gripper 24. As indicated in FIG. 3, the opening 78 includes a round central opening for receiving the grid and a pair of slots extending from opposite sides of the round central opening. Each of the slots is dimensioned to receive one of the two fingers of the grid gripper 24.

In the embodiment of FIG. 3, a compliance device 68 is positioned between the bracket 62 and the gripper actuator 72 of the holder gripper 26. The compliance device 68 reduces the magnitudes of forces resulting from relatively small lateral and/or rotational misalignments occurring when the robotic arm 18 inserts the specimen holder 50 into the airlock entryway 52 of the TEM 42. These forces would otherwise be transmitted from the holder gripper 26 to the force sensor 22. The compliance device 68 preferably uses springs or pneumatic pistons rather than elastomeric materials for greater durability. A suitable compliance device is the model number 1818 manufactured by the Robotic Accessories Division of the Process Equipment Company (Tipp City, Ohio).

FIG. 4 is a front elevation view of the grid gripper 24 of FIGS. 1 and 3 illustrating the two opposed fingers of the grid gripper 24 attached to the actuator 64. The finger 66A of FIG. 3 is shown in FIG. 4, as is a similar finger 66B opposed to the finger 66A. As indicated in FIG. 4, the finger 66A has a “V”-shaped notch 90 on a surface adjacent to the opposed finger 66B, and the finger 66B has a similar notch 92 on a surface adjacent to the opposed finger 66A. The notches 90 and 92 are substantially aligned with one another.

When the grid gripper 24 grips a grid, the fingers 66A and 66B move apart in unison and are positioned on either side of the grid. The fingers 66A and 66B then move toward one another in unison until an outer edge surface of the grid on opposite sides of the grid fit into and contact the notches 90 and 92 (i.e., until the notches 90 and 92 engage the outer edge surface of the grid on the opposite sides).

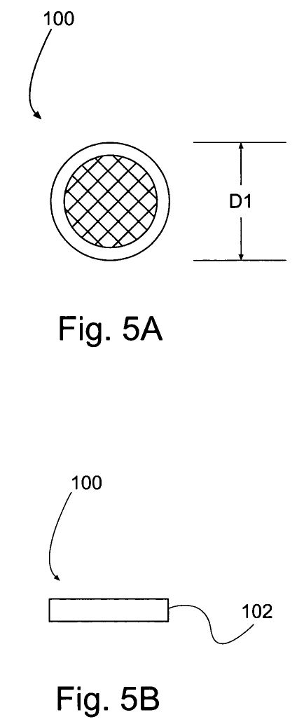

FIG. 5A is a top plan view of a typical specimen grid (i.e., grid) 100, and FIG. 5B is a side elevation view of the typical grid 100 of FIG. 5A. As apparent in FIGS. 5A and 5B, the typical grid 100 is disk shaped. The grid 100 is made of a metal, and has a solid outer portion encircling a central portion having an array of holes forming a screen pattern. A specimen to be examined using the TEM 42 of FIG. 1 is positioned on the central portion of the grid 100. The typical grid 100 has a diameter “D1” of about 0.12 in. An outer edge surface 102 of the typical grid 100 is shown in FIG. 5B. The “V”-shaped notches 90 and 92 of the fingers 66A and 66B of the grid gripper 24 of FIGS. 3-4 are adapted to engage the outer edge surface 102 of the grid 100 on opposite sides of the grid 100.

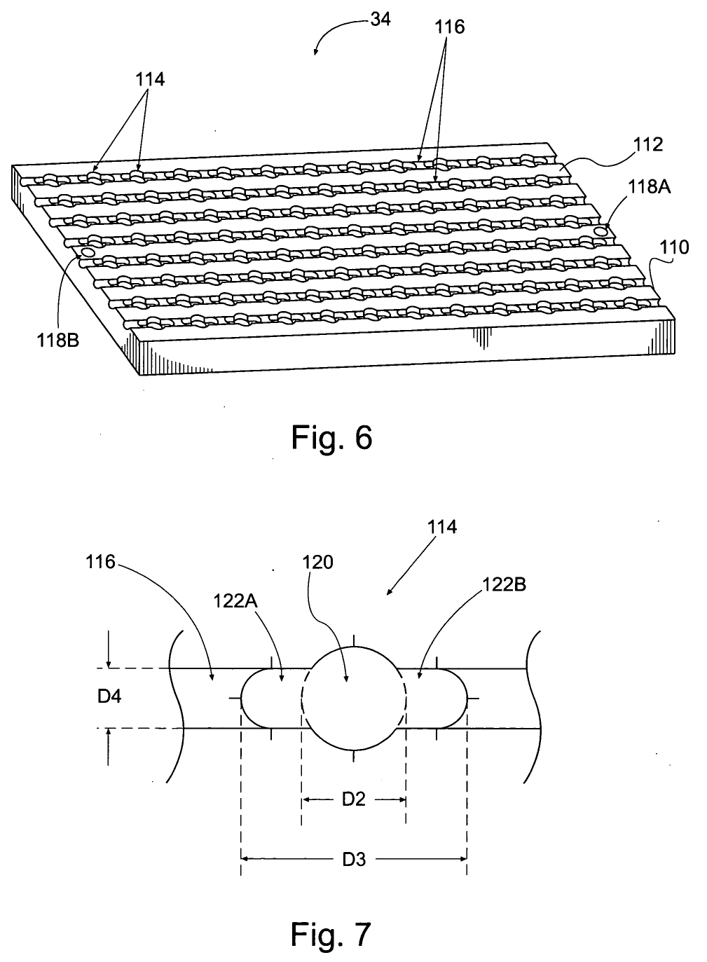

FIG. 6 is a perspective view of one embodiment of the grid tray 34 of FIGS. 1 and 2. In the embodiment of FIG. 6, the grid tray 34 includes a base 110 having a substantially flat upper surface 112. Multiple cavities or pockets 114 are formed in the upper surface 112 for storing grids. In the embodiment of FIG. 6, the pockets 114 are arranged to form a two dimensional array. Each of the pockets 114 is adapted to receive a grid, and also to allow the fingers 66A and 66B of the grid gripper 24 (FIGS. 3 and 4) to be positioned on opposite sides of a grid positioned therein.

In the embodiment of FIG. 6, the two dimensional array of pockets 114 includes 8 rows and 12 columns. The grid tray 34 thus includes a total of 96 pockets 114. In addition to the pockets 114, the grid tray 36 also includes 8 grooves 116. Each of the grooves 116 passes through a center of the pockets 114 in a corresponding row of the array of pockets 114.

The grid tray 34 also includes two holes 118A and 118B extending through the grid tray 34 on opposite sides. Each of the holes 118A and 118B is dimensioned to receive one of two positioning pins extending upward from the work surface 32 of FIG. 1. The positioning pins ensure precise and consistent positioning of the grid tray 34 on the work surface 32.

FIG. 7 is a top plan view of one of the pockets 114 of FIG. 6. As shown in FIG. 7, the pocket 114 has a central cavity 120 and slots 122A and 122B extending from opposite sides of the central cavity 120. The central cavity 120 is substantially circular in cross section and is dimensioned to receive a grid. In one embodiment grids have an outer diameter of about 0.12 in., the cavity 120 diameter “D2” of about 0.125 in., and the cavity 120 has a substantially flat bottom surface.

The slots 122A and 122B on either side of the central cavity 120 are each dimensioned to allow a different one of the fingers 66A and 66B of the grid gripper 24 of FIGS. 3 and 4 to be positioned adjacent to an edge of a grid located in the central cavity 120. In the embodiment of FIG. 7, the slots 122A and 122B have depths greater than a depth of the central cavity 120 to facilitate gripping of the grid by the fingers 66A and 66B of the grid gripper 24. In one embodiment, the slots 122A and 122B have a width dimension “D4” of about 0.08 in and the opening 114 has a major dimension “D3” of approximately 0.208 in.

As described above, one of the grooves 116 passes through the slots 122A-122B and the central cavity 120. In the embodiment of FIG. 7, a width of the groove 112 is substantially equal to the width dimension “D4” of the slots 122A and 122B.

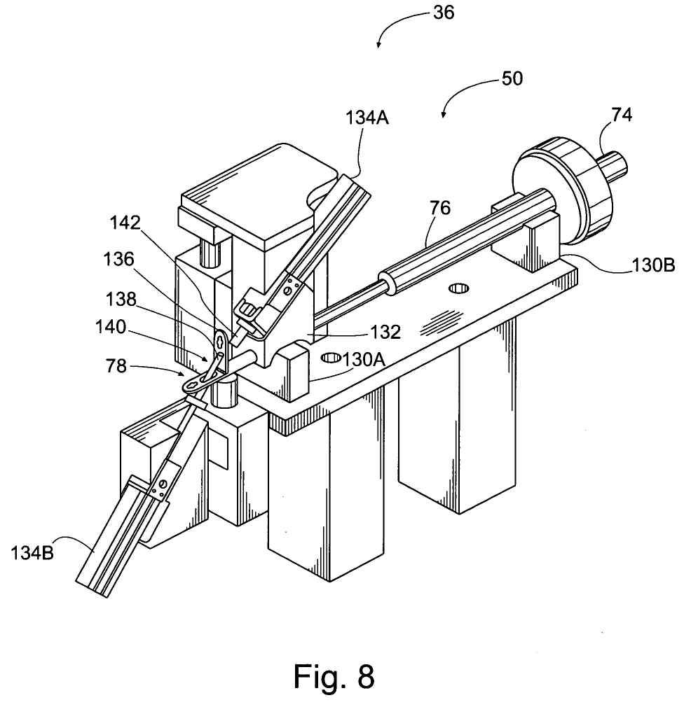

FIG. 8 is a perspective view of one embodiment of the probe station 36 of FIGS. 1 and 2. In the embodiment of FIG. 8 the probe station 36 includes two “U”-shaped cradles 130A and 130B for supporting the specimen holder 50 and a vertical locking member 132 including a clamping portion and two actuators 134A and 134B. The two “U”-shaped cradles 130A and 130B are adapted for supporting the probe end 76 of the specimen holder 50. (Several parts of the specimen holder 50 are labeled in FIG. 3.)

In FIG. 8 the vertical locking member 132 is in a lowered positioned. In the lowered position the clamping portion of the vertical locking member 132 contacts and applies a downward force to an upper surface of the probe end 76 of the specimen holder 50 at the cradle 130A, holding the specimen holder 50 firmly in position on the cradles 130A and 130B.

As illustrated in FIG. 8, the specimen holder 50 includes a clamping arm 136 for holding a grid in the opening 78 at the tip of the probe end 76. In FIG. 8 the clamping arm 136 is shown in a raised position. When the clamping arm 136 is in the raised position, a grid may be positioned in, or removed from, the opening 78 (e.g., by the grid gripper 24 of FIGS. 3 and 4).

The actuator 134B has a rod 138 for moving the clamping arm 136 to the raised position. In FIG. 8 a tip of the rod 138 passes through a hole 140 in the probe end 76 of the specimen holder 50 adjacent to the opening 78, and is in contact with the clamping arm 136. The actuator 134A has a rod 142 for moving the clamping arm 136 to a lowered position. In the lowered position the clamping arm 136 prevent a grid positioned in the opening 78 from exiting the opening 78.

The vertical locking member 132 may also be moved to a raised position as indicated in FIG. 8. When the vertical locking member 132 is in the raised position the specimen holder 50 may be lifted from the cradles 130A and 130B (e.g., by the holder gripper 26 of FIG. 4).

FIGS. 1-8 will now be used to describe a typical sequence of operations performed by the system 10. In a first step, a user (i.e., operator) selects one of the 96 grids holding a specimen to be examined using the TEM 42, and initiates loading operations, via the user interface 16 of the local monitor 14 (or remotely via the network).

The PC 12 signals the probe station 36 to raise the clamping arm 136 of the specimen holder 50 positioned in the cradles 130A and 130B. Using the grid gripper 24, the robotic arm 18 grips the selected grid in a corresponding pocket 114 of the grid tray 34. The robotic arm 18 transfers the grid from the grid tray 34 to the probe station 36, and positions the grid in the opening 78 at the tip of the specimen holder 50.

The probe station 36 closes the clamping arm 136 of the specimen holder 50. Using the holder gripper 26, the robotic arm 18 grips the specimen holder 50 at the handle end. The robotic arm 18 transfers the specimen holder 50 from the probe station 36 to a position adjacent to the airlock entryway 52 of the TEM 42. Using the camera 38, the PC 12 verifies that the location of the TEM 42 has not changed.

After verifying that the location of the TEM 42 has not changed, the PC 12 sends a signal to the controller 28. When the controller 28 receives the signal, the controller 28 directs the robotic arm 18 to insert specimen holder 50 into the airlock entryway 52 of the TEM 42.

The signal(s) from the force sensor 22 are used to perform one or more steps required to properly position the specimen holder 50 within the airlock entryway 52 of the TEM 42. When the specimen holder 50 is properly positioned within the airlock entryway 52, the robotic arm 18 disengages the holder gripper 26 from specimen holder 50. The PC 12 issues a software signal, via the network 45 to the TEM PC 43 for confirmation.

Following examination of the specimen within the TEM 42, the TEM PC 43 issues another software signal to the PC 12 via the network 45, causing the PC 12 to issue a signal to the controller 28 indicating that the specimen holder 50 is to be removed from the TEM 42.

When the controller 28 receives the signal, the controller 28 directs the robotic arm 18 to remove the specimen holder 50 from the airlock entryway 52 of the TEM 42.

After removing the specimen holder 50 from the airlock entryway 52 of the TEM 42, the robotic arm 18 transfers the specimen holder 50 from the TEM 42 to the probe station 36. The probe station 36 lowers the member 132, then raises the clamping arm 136 of the specimen holder 50 to the raised position. Using the grid gripper 24, the robotic arm 18 grips the grid positioned in the opening 78 at the tip of the specimen holder 50. The robotic arm 18 transfers the grid from the probe station 36 to the grid tray 34, and replaces the grid in the corresponding pocket 114 of the grid tray 34. The above actions may be repeated to sequence multiple specimens between the grid tray 34 and the TEM 42.

While the invention has been described with reference to at least one preferred embodiment, it is to be clearly understood by those skilled in the art that the invention is not limited thereto. Rather, the scope of the invention is to be interpreted only in conjunction with the appended claims.

1. A system for conveying a specimen-bearing grid from a first location to a second location, the system comprising:
a robotic arm;
an end effector attached to an end of the robotic arm and comprising a gripper apparatus adapted to grip the grid; and
a control means operably connected to the robotic arm and to the gripper apparatus and configured to control the robotic arm and the gripper apparatus such that the gripper apparatus grips the grid at the first location and the robotic arm conveys the gripped grid from the first location to the second location.

2. The system as recited in claim 1, wherein the gripper apparatus comprises a pair of opposed fingers coupled to at least one actuator.

3. The system as recited in claim 2, wherein the grid is substantially disk shaped and comprises an outer edge surface, and wherein each of the opposed fingers comprises a “V”-shaped notch adapted to engage the outer edge surface of the grid.

4. A system for inserting a specimen-containing holder into a microscope, comprising:
a robotic arm;
an end effector attached to an end of the robotic arm and comprising a gripper apparatus adapted to grip the holder; and
a control means operably connected to the robotic arm and to the gripper apparatus and configured to control the robotic arm and the gripper apparatus such that the gripper apparatus grips the holder, and the robotic arm inserts the gripped holder into the microscope.

5. The system as recited in claim 4, wherein the gripper apparatus comprises a pair of opposed fingers coupled to at least one actuator.

6. The system as recited in claim 5, wherein the at least one actuator comprises a pneumatic actuator.

7. The system as recited in claim 4, wherein the holder comprises a handle portion at one end and a specimen-containing probe portion at an opposite end, and wherein the gripper apparatus is adapted to grip the handle portion.

8. The system as recited in claim 4, wherein the end effector further comprises a force sensor operably connected to the control means and configured to provide a signal indicative of a force present in the end effector to the control means, and wherein the control means is configured to control the robotic arm dependent upon the signal.

9. The system as recited in claim 8, wherein the end effector further comprises a compliance device operably connected between the gripper apparatus and the force sensor and configured to reduce a magnitude of a force resulting from a relatively small misalignment occurring when the robotic arm inserts the holder into the microscope.

10. A system for inserting a holder containing a specimen-bearing grid into a microscope, the system comprising:
a robotic arm;
an end effector attached to an end of the robotic arm and comprising:
a first gripper apparatus adapted to grip the grid;
a second gripper apparatus adapted to grip the holder;
a control means operably connected to the robotic arm and to the gripper apparatus and configured to control the robotic arm and the first and second gripper apparatus such that:
the first gripper apparatus grips the grid at a first location;
the robotic arm conveys the gripped grid from the first location to a second location;
the first gripper apparatus releases the grid at the second location such that the grid is positioned in the holder;
the second gripper apparatus grips the holder at the second location; and
the robotic arm inserts the gripped holder into the microscope.

11. The system as recited in claim 10, wherein the first and second gripper apparatus each comprise a pair of opposed fingers coupled to at least one actuator.

12. The system as recited in claim 10, wherein the holder comprises a handle portion at one end and a specimen-containing probe portion at an opposite end, and wherein the second gripper apparatus is adapted to grip the handle portion.

13. The system as recited in claim 10, wherein the end effector further comprises a force sensor operably connected to the control means and configured to provide a signal indicative of a force present in the end effector to the control means, and wherein the control means is configured to control the robotic arm dependent upon the signal.

14. The system as recited in claim 13, wherein the end effector further comprises a compliance device operably connected between the gripper apparatus and the force sensor and configured to reduce a magnitude of a force resulting from a relatively small misalignment occurring when the robotic arm inserts the holder into the microscope.

15. The system as recited in claim 10 wherein the control means includes a PC and a local TEM PC operable connected by a network.

16. The system as recited in claim 10 further including a vision analysis means for focusing in on a point of interest on the specimen-bearing grid.

17. A tray for storing a plurality of specimen grids, comprising:
a base comprising a substantially flat upper surface having a plurality of pockets formed therein, wherein each of the pockets comprises:
a central cavity adapted to receive one of the specimen grids; and
a pair of slots extending from opposite sides of the central cavity, wherein
each of the slots is adapted to receive a finger of a gripper apparatus.

18. The tray as recited in claim 17, wherein the pockets are arranged to form a two dimensional array having a plurality of rows and a plurality of columns.

19. The tray as recited in claim 18, further comprising a plurality of grooves, wherein each of the grooves corresponds to a different one of the rows of the two dimensional array and passes through the pockets in the corresponding row.

20. The tray as recited in claim 17, further comprising a pair of holes each adapted to receive a positioning pin.

21. A probe station for loading a specimen-bearing grid into a holder, wherein the holder comprises a clamping arm for containing the grid within the holder, the probe station comprising:
a pair of “U”-shaped cradles for supporting the holder;
a vertical locking member, comprising:
a clamping portion;
a first actuator configured to raise the clamping arm of the holder; and
a second actuator configured to lower the clamping arm.

22. The probe station as recited in claim 21, wherein the vertical locking member is actuated between a raised position and a lowered position, and wherein in the lowered position the clamping portion applies a downward force to a holder positioned in the cradles, thereby holding the holder in the cradles.

23. The probe station as recited in claim 21, further comprising a first rod coupled to the first actuator for contacting the clamping arm of the holder, and a second rod coupled to the second actuator for contacting the clamping arm.
